(19) United States
(12) Patent Application Publication
(10) Pub. No.: US 2019/0236011 A1
(43) Pub. Date: Aug. 1, 2019

(54) MEMORY STRUCTURE BASED COHERENCY DIRECTORY CACHE

(71) Applicant: HEWLETT PACKARD ENTERPRISE DEVELOPMENT LP, Houston, TX (US)

(72) Inventors: Frank R. DROPPS, Eagan, MN (US); Thomas E. MCGEE, Chippewa Falls, WI (US)

(73) Assignee: HEWLETT PACKARD ENTERPRISE DEVELOPMENT LP, Houston, TX (US)

(21) Appl. No.: 15/885,530

(22) Filed: Jan. 31, 2018

(51) Int. Cl. G06F 12/0817; G06F 17/30; G06F 12/0811; G06F 12/123; G06F 12/128

(52) U.S. Cl. CPC G06F 12/0828; G06F 17/30982; G06F 12/0811; G06F 2212/283; G06F 12/128; G06F 2212/621; G06F 12/123

(57) ABSTRACT

In some examples, with respect to memory structure based coherency directory cache implementation, a hardware sequencer may include hardware to identify, for a coherency directory cache that includes information related to a plurality of cache lines, adjacent cache lines. A state associated with each of the adjacent cache lines may be determined. Based on a determination that the state associated with one of the adjacent cache lines is identical to the state associated with remaining active adjacent cache lines, the adjacent cache lines may be grouped. The hardware sequencer may utilize, for the coherency directory cache, an entry in a memory structure to identify the grouped cache lines. Data associated with the entry in the memory structure may include greater than two possible memory states.

### BACKGROUND

With respect to cache coherence, directory-based coherence may be implemented for non-uniform memory access (NUMA), and other such memory access types. In this regard, a coherency directory may include entry information to track the state and ownership of each memory block that may be shared between processors in a multiprocessor shared memory system. A coherency directory cache may be described as a component that stores a subset of the coherency directory entries providing for faster access and increased data bandwidth. For directory-based coherence, the coherency directory cache may be used by a node controller to manage communication between different nodes of a computer system or different computer systems. In this regard, the coherency directory cache may track the status of each cache block (or cache line) for the computer system or the different computer systems. For example, the coherency directory cache may track which of the nodes of the computer system or of different computer systems are sharing a cache block.

### BRIEF DESCRIPTION OF DRAWINGS

Features of the present disclosure are illustrated by way of example and not limited in the following figure(s), in which like numerals indicate like elements, in which:

FIG. 1 illustrates an example layout of a memory structure based coherency directory cache implementation apparatus, and associated components;

FIG. 2 illustrates a process flow of a process state machine to illustrate operation of the memory structure based coherency directory cache implementation apparatus of FIG. 1;

FIG. 3 illustrates a scrubber flow of a background scrubbing state machine to illustrate operation of the memory structure based coherency directory cache implementation apparatus of FIG. 1;

FIG. 4 illustrates an example block diagram for memory structure based coherency directory cache implementation;

FIG. 5 illustrates an example flowchart of a method for memory structure based coherency directory cache implementation; and

FIG. 6 illustrates a further example block diagram for memory structure based coherency directory cache implementation.

### DETAILED DESCRIPTION

For simplicity and illustrative purposes, the present disclosure is described by referring mainly to examples. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure.

Throughout the present disclosure, the terms “a” and “an” are intended to denote at least one of a particular element. As used herein, the term “includes” means includes but not limited to, the term “including” means including but not limited to. The term “based on” means based at least in part on.

Memory structure based coherency directory cache implementation apparatuses, methods for operating memory structure based coherency directory caches, and non-transitory computer readable media having stored thereon machine readable instructions to provide a memory structure based coherency directory cache are disclosed herein. The apparatuses, methods, and non-transitory computer readable media disclosed herein provide for utilization of a ternary content-addressable memory (TCAM) to implement a coherency directory cache.

A coherency directory cache may include information related to a plurality of memory blocks. The size of these memory blocks may be defined for ease of implementation to be the same as system cache lines for a computer system. These cache line sized memory blocks for discussion clarity may be referred to as cache lines. The cache line information may identify a processor (or another device) at which the cache line is stored in the computer system (or different computer systems). The coherency directory and coherency directory cache may include a coherency state and ownership information associated with each of the system memory cache lines. As the number of cache lines increases, the size of the coherency directory and likewise the coherency directory cache may similarly increase. For performance reasons, the increase in the size of the coherency directory cache may result in a corresponding increase in usage of a die area associated with the coherency directory cache, and a similar increase in power usage associated with the coherency directory cache. In this regard, it is technically challenging to implement the coherency directory cache with reduced usage of the die area associated with the coherency directory cache, and reduced power usage associated with the coherency directory cache.

In order to address at least the aforementioned technical challenges, the apparatuses, methods, and non-transitory computer readable media disclosed herein provide for reduction of the die size impact of the increased directory size and/or reduction in system power utilization by utilizing a coherency directory cache that holds coherency directory information for a subset of the system cache lines. In addition or in other examples, the extra die area and power may be used to provide a larger coherency directory cache to thus increase system performance. In this regard, the coherency directory cache may be implemented by utilization a TCAM. A property of the TCAM includes the ability to select “don't care” (or “wildcard”) (e.g., “X”) bits. The “don't care” bits may be used to represent information related to multiple adjacent cache lines with the same TCAM entry. In this regard, the adjacent cache lines may be grouped in accordance with identical ownership and state information.

For example, for the memory structure based coherency directory cache implementation, adjacent cache lines may be identified for a coherency directory cache that includes information related to a plurality of cache lines. A state and an ownership associated with each of the adjacent cache lines may be determined. Based on a determination that the state and the ownership associated with one of the adjacent cache lines are respectively identical to the state and the ownership associated with remaining active adjacent cache lines, the adjacent cache lines may be grouped. Further, a single entry in a TCAM may be used for the coherency directory cache to identify the information related to the grouped cache lines.

For the apparatuses, methods, and non-transitory computer readable media disclosed herein, the elements (e.g., components) of the apparatuses, methods, and non-transitory computer readable media disclosed herein may be any combination of hardware and programming to implement the functionalities of the respective elements. In some examples described herein, the combinations of hardware and programming may be implemented in a number of different ways. For example, the programming for the elements may be processor executable instructions stored on a non-transitory machine-readable storage medium and the hardware for the elements may include a processing resource to execute those instructions. In these examples, a computing device implementing such elements may include the machine-readable storage medium storing the instructions and the processing resource to execute the instructions, or the machine-readable storage medium may be separately stored and accessible by the computing device and the processing resource. In some examples, some or all elements may be implemented in hardware circuitry.

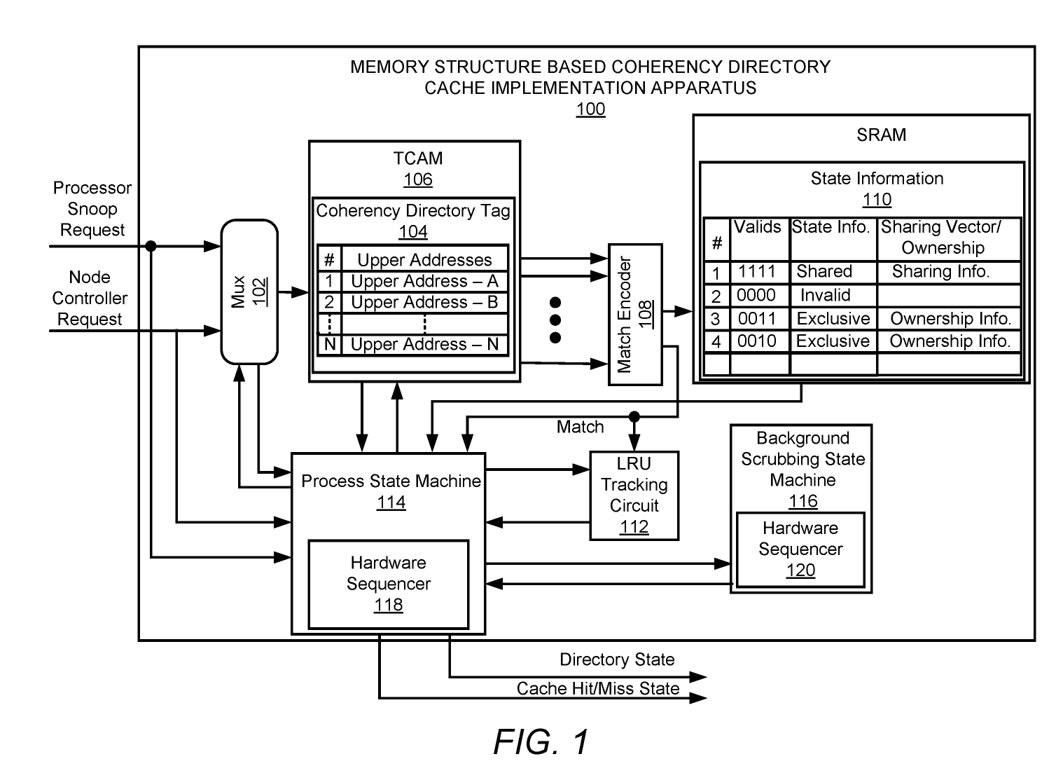

FIG. 1 illustrates an example layout of a memory structure based coherency directory cache implementation apparatus (hereinafter also referred to as “apparatus 100”).

Referring to FIG. 1, the apparatus 100 may include a multiplexer 102 to receive requests such as a processor snoop request or a node controller request. A processor snoop request may be described as an operation initiated by a local processor to inquire about the state and ownership of a memory block or cache line. A node controller request may be described as an operation initiated by a remote processor or remote node controller that was sent to a local node controller including apparatus 100. The requests may be directed to a coherency directory tag 104 to determine whether state information is present with respect to a particular memory block (i.e., cache line). The coherency directory tag 104 may include information related to a plurality of memory blocks. That is, the coherency directory tag 104 may include a collection of upper addresses that correspond to the system memory blocks or cache lines where the state and ownership information is being cached in the coherency directory cache. For example, the upper addresses may include upper address-A, upper address-B, . . . , upper address-N, etc. Each upper address may have a corresponding row number (e.g., row number 1, 2, . . . , N) associated with each entry. Each upper address may be 0-N don't care bits depending on the location. As disclosed herein, the size of these memory blocks may be defined for ease of implementation to be the same as system cache lines for a computer system (or for different computer systems). These cache line sized memory blocks for discussion clarity may be referred to as cache lines.

Ownership may be described as an identification as to what node or processor has ownership of the tracked system memory block or cache line. In a shared state, ownership may include the nodes or processors that are sharing the system memory block or cache line.

The requests may be processed by a TCAM 106. For the TCAM 106, each cache entry may include a TCAM entry to hold an upper address for comparison purposes with the requests. This upper address may be referred to as a tag. With respect to the upper address, a processor system may include a byte or word address that allows for the definition of the bits of data being accessed. When multiple bytes or words are grouped together into larger blocks, such as cache lines, the upper address bits may be used to uniquely locate each block or cache line of system memory, and lower address bits may be used to uniquely locate each byte or word within the system memory block or cache line.

A tag may be described as a linked descriptor used to identify the upper address. A directory tag may be described as a linked descriptor used in a directory portion of a cache memory. The coherency directory tag 104 may include all of the tags for the coherency directory cache, and may be described as a linked descriptor used in a directory portion of a coherency directory cache memory. The coherency directory tag 104 may include the upper address bits that define the block of system memory being tracked.

The directory tags may represent the portion of the coherency directory cache address that uniquely identifies the directory entries. The directory tags may be used to detect the presence of a directory cache line within the coherency directory tag 104, and, if so, the matching entry may identify where in the directory state storage the cached information is located. One coherency directory cache entry may represent the coherency state and ownership of a single system cache line of memory.

At the match encoder 108, a request processed by the TCAM 106 may be processed to ascertain a binary representation of the associated row (e.g., address) of the coherency directory tag 104. For the TCAM 106, each row or entry of the TCAM 106 may include a match line that is activated when that entry matches the input search value. For example, if the TCAM 106 has 1024 entries, it will output 1024 match lines. These 1024 match lines may be encoded into a binary value that may be used, for example, for addressing the memory that is storing the state and ownership information. For example, if match line 255 is active, the encoded output from match encoder 108 would be OFF₁₆.

A state information 110 block may include the current representation of the state and ownership of the memory block (i.e., cache line) for the request processed by the TCAM 106. For example, the state information 110 may include a “valids” column that includes a set of valid bits (e.g., 1111, 0000, 0011, 0010), a “state info.” column that includes information such as shared, invalid, or exclusive, and a “sharing vector/ownership” column that includes sharing information for a shared state, and ownership for the exclusive state. According to an example, the rows of the state information 110 may correspond to the rows of the coherency directory tag 104. Alternatively, a single row of the coherency directory tag 104 may correspond to multiple rows of the state information 110. With respect to coherency directory tag 104 and the state information 110, assuming that upper address-A covers four cache lines that are all valid, these four cache lines may include the same state information and sharing vector/ownership. The length of the valid bits may correspond to a number of decodes of the don't care bits. The coherency directory cache output information related to the memory block state and ownership information may also include a directory cache hit indicator status (e.g., a coherency directory tag 104 hit) or a directory cache miss indicator status responsive to the requests received by the multiplexer 102. The ownership may include an indication of a node (or nodes) of a computer system or different computer systems that are sharing the memory block. In this regard, the actual information stored may be dependent on the implementation and the coherency protocol that is used. For example, if the protocol being used includes a shared state, the ownership information may include a list of nodes or processors sharing a block. The state and ownership may be retrieved from the state information 110 memory storage based on the associated matching row from the TCAM 106 as encoded into a memory address by match encoder 108.

The directory hit or a directory miss information may be used for a coherency directory cache entry replacement policy. For example, the replacement policy may use least recently used (LRU) tracking circuit 112. The least recently used tracking circuit 112 may evict a least recently used cache entry if the associated cache is full and a new entry is to be added. In this regard, if an entry is evicted, the TCAM 106 may be updated accordingly. When the TCAM 106 is full, the complete coherency directory cache may be considered full. The LRU tracking circuit 112 may receive hit/miss information directly from the match encoder 108. However, the hit/miss information may also be received from the process state machine 114. When a cache hit is detected, the LRU tracking circuit 112 may update an associated list to move the matching entry to the most recently used position on the list.

Tag data associated with an entry in the TCAM 106 may include the possible memory states of “0”, “1”, or “X”, where the “X” memory state may represent “0” or “1”, and may be designated as a “don't care” memory state. The least significant digit in the TCAM 106 of a cache line address may define the address of the cache line within a group of cache lines. The least significant digits may be represented by the “X” memory state. Thus, one coherency directory cache entry may represent the state of several (e.g., 2, 4, 8, 16, etc.) system cache lines of memory. These memory blocks or system cache lines may be grouped by powers of 2, as well as non-powers of 2. For non-powers of 2, a comparison may be made on the address with respect to a range. For example, if the address is between A and C, then the memory blocks or system cache lines may be grouped. Thus, each TCAM entry may represent any number of system cache lines of memory. These multiple cache lines may be grouped based on a determination that the multiple cache lines are adjacent, and further based on a determination that the multiple cache lines include the same state and ownership to share a TCAM entry. In this regard, the adjacent cache lines may include cache lines that are within the bounds of a defined group. Thus, adjacent cache lines may include cache lines that are nearby, in close proximity, or meet a group addressing specification.

A process state machine 114 may analyze, based on the requests such as the processor snoop request and/or the node controller request, state and ownership information for associated cache lines to identify cache lines that may be consolidated with respect to the TCAM 106.

A background scrubbing state machine 116 may also analyze state and ownership information associated with adjacent cache lines to identify cache lines that may be consolidated with respect to the TCAM 106. Thus, with respect to consolidation of cache lines, the process state machine 114 may perform the consolidation function when adding a new entry, and the background scrubbing state machine 116 may perform the consolidation function as a background operation when the coherency director cache is not busy processing other requests. With respect to the background operation performed by the background scrubbing state machine 116, the state and ownership information may change over time. When information with respect to a given block was originally written and could not be grouped because the state or ownership information did not match the information of other blocks that would be in the combined group, this information for the given block may correspond to a separate coherency directory cache entry. If, at a later time, some of the information related to state or ownership changes, the grouping may now possibly occur. Thus, the background scrubbing state machine 116 may operate when the requests such as the processor snoop request and/or the node controller request are not being processed. In this regard, the background scrubbing state machine 116 may find matching entries and rewrite the TCAM entries to perform the grouping of memory blocks to be represented by a single entry as disclosed herein.

The functionality of the process state machine 114 and the background scrubbing state machine 116 with respect to grouping of adjacent cache lines that include identical state and ownership may be respectively performed by a hardware sequencer 118 and a hardware sequencer 120, or other circuits included in the process state machine 114 and the background scrubbing state machine 116. Certain functions that are performed by both the hardware sequencer 118 and the hardware sequencer 120 are described below.

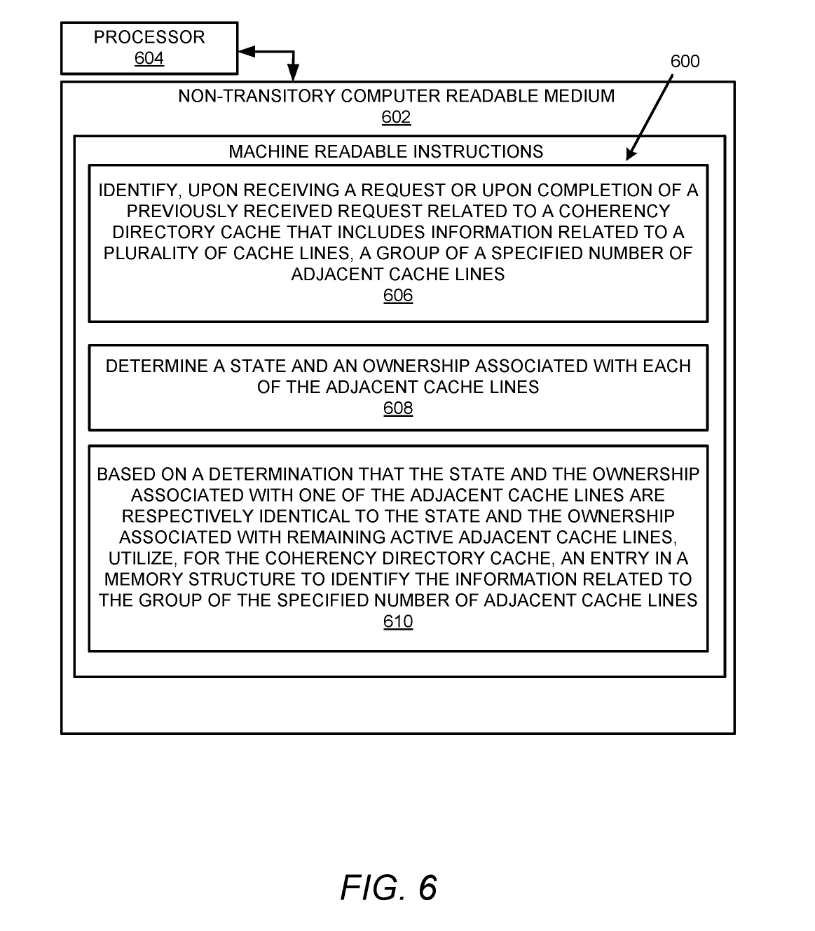

According to examples, the hardware sequencer 118 and the hardware sequencer 120 may include hardware to identify, for the coherency directory tag 104 that includes information related to a plurality of cache lines, adjacent cache lines. In an example, the hardware sequencer 118 and the hardware sequencer 120 may be hardware state machines or may be part of a larger state machine. Alternatively, the apparatus 100 may include a processor (e.g., the processor 604 of FIG. 6) to implement some or all of the steps (which may be implemented as instructions by the processor) of the hardware sequencer 118 and the hardware sequencer 120.

For the implementation of the apparatus 100 including the hardware sequencer 118 and the hardware sequencer 120, the hardware sequencer 118 and the hardware sequencer 120 may further include hardware to determine a state and an ownership associated with each of the adjacent cache lines.

Based on a determination that the state and the ownership associated with one of the adjacent cache lines are respectively identical to the state and the ownership associated with remaining active adjacent cache lines, the hardware sequencer 118 and the hardware sequencer 120 may further include hardware (or processor implemented instructions) to group the adjacent cache lines. Grouping the adjacent cache lines may include setting a “don't care” bit if needed to include the cache line to be added, and setting the corresponding valid bit of the validity field. In this regard, an equality based comparison may be used to determine if the two items of information with respect to the state and ownership are the same. The remaining active cache lines may be described as the cache lines currently represented within that group in the coherency directory cache (e.g., the remaining active cache lines may include the valid bits set in the state information).

The hardware sequencer 118 and the hardware sequencer 120 may further include hardware (or processor implemented instructions) to utilize, for the coherency directory tag 104, an entry in a memory structure to identify the information (e.g., the address bits) related to the grouped cache lines. In this regard, data associated with the “don't care” entry in the memory structure may include greater than two possible memory states. According to examples, the entry may include an address that uniquely identifies the entry in the memory structure. For instance, the entry may include an address without any “don't care” bits.” According to examples, the entry may include a single entry in the memory structure to identify the information related to the grouped cache lines. For instance, the entry may include an address with one or more of the least significant digits as “don't care” bits. According to examples, a number of the grouped cache lines may be equal to four adjacent cache lines. For instance, the entry may include an address with the two least significant digits as “don't care” bits.

According to examples, the memory structure may include the TCAM 106 as shown in FIG. 1. For the TCAM 106, the hardware sequencer 118 and the hardware sequencer 120 may further include hardware (or processor implemented instructions) to write a specified number of lower bits of the address as “X” bits. In this regard, the data associated with the entry in the TCAM 106 may include the possible memory states of “0”, “1”, or “X”, where the “X” memory state (e.g., the “don't care” memory state) may represent “0” or “1”. For example, the lower two bits of the upper address (tag) may be programmed within the TCAM as “don't care” when an entry is written into the coherency directory tag 104. This example illustrates the configuration when a single coherency cache entry covers a group of up to four system cache lines. The state information may include a 4-bit valid field. The implementation with the 4-bit valid field may represent an implementation where the two least significant upper address bits may be allowed to be “don't care”. In this regard, with respect to other implementations, a number of bits in the validity field would change. For example, for an implementation with up to 3 “don't care” bits, the valid field would be 8 bits long, because there are 2″3=8 (or generally, 2̂n, where n represents the number of “don't care” bits) unique decodes of the three lower address bits. With respect to the state information that includes a 4-bit valid field, each of these 4 bits may correspond to a decode of the lower two bits of the upper address allowing an association of each bit with one of the four cache lines within the four cache line group. These 4 bits may be considered as valid bits for each of the four system memory cache lines. Each TCAM entry may now represent the state and ownership information for anywhere from zero, not a valid entry, to four cache lines of system memory. Further, the hardware sequencer 118 and the hardware sequencer 120 may further include hardware (or processor implemented instructions) to designate, based on the written lower bits, coherency directory cache tracking as valid for each cache line of the grouped cache lines. The coherency directory cache tracking may be described as the coherency directory cache monitoring the status of whether the bit is active or inactive.

The hardware sequencer 118 and the hardware sequencer 120 may further include hardware (or processor implemented instructions) to utilize the entry to designate zero cache lines, not a valid entry associated with the cache lines, or a specified number of the adjacent cache lines, where the specified number is greater than one.

A search of the TCAM 106 may be performed to determine whether a new entry is to be added. The search of the TCAM 106 may be performed using the upper address bits of the cache line corresponding to the received request. If there is a TCAM miss then the tag may be written into an unused entry. In this regard, the hardware sequencer 118 may further include hardware (or processor implemented instructions) to designate the entry as a new entry, and determine whether the coherency directory cache memory structure includes a previous entry corresponding to the same group as the new entry. In this regard, based on a determination that the coherency directory cache memory structure does not include the previous entry corresponding to the same group as the new entry, the new entry may be added into an unused entry location of the coherency directory cache memory structure.

When a new entry is to be added, a search of the TCAM 106 may be performed. If all cache entries are used, then a least recently used entry may be evicted and the new tag may be written into that TCAM entry. In this regard, the hardware sequencer 118 may further include hardware (or processor implemented instructions) to designate the entry as a new entry, and determine whether the memory structure includes a previous entry corresponding to the same group as the new entry. Based on a determination that the memory structure does not include the previous entry corresponding to the new entry, the hardware sequencer 118 may further include hardware (or processor implemented instructions) to determine whether all entry locations in the memory structure are used. Based on a determination that all entry locations in the memory structure are used, the hardware sequencer 118 may further include hardware (or processor implemented instructions) to evict a least recently used entry of the memory structure. Further, the new entry may be added into an entry location corresponding to the evicted least recently used entry of the memory structure.

If during the TCAM search there is a match between the new upper address bits and a tag entry within the TCAM, the 4-bit field discussed above may be examined. If the corresponding bit in the 4-bit field, as selected by a decode of the lower two bits of the upper address, is set, then a cache hit may be indicated and processing may continue. In this regard if a cache hit is not determined, the hardware sequencer 118 may further include hardware (or processor implemented instructions) to designate the entry as a new entry, and determine whether the memory structure includes a previous entry corresponding to the new entry. Based on a determination that the memory structure includes the previous entry corresponding to the new entry, the hardware sequencer 118 may further include hardware (or processor implemented instructions) to determine, for the previous entry, whether a specified bit corresponding to the new entry is set. Further, based on a determination that the specified bit is set, the hardware sequencer 118 may further include hardware (or processor implemented instructions) to designate the new entry as a cache hit.

If the corresponding bit in the 4-bit field discussed above is not set, then a comparison may be made of the state and ownership information. If the state and ownership information is the same for the new system memory cache line and the cached value of the state and ownership information, then the corresponding bit in the 4-bit field may be set to add this new system memory cache line to the coherency directory tag 104. The state and ownership field may apply to all cache lines matching the address field and that have a corresponding valid bit in the 4-bit validity field. Thus, if the state and ownership of the cache line being evaluated match the state and ownership field, then the corresponding bit of the validity field may be set. With respect to the state and ownership information, based on a determination that the specified bit is not set, the hardware sequencer 118 may further include hardware (or processor implemented instructions) to determine whether a state and an ownership associated with the new entry are respectively identical to the state and the ownership associated with the previous entry. Further, based on a determination that the state and the ownership associated with the new entry are respectively identical to the state and the ownership associated with the previous entry, the hardware sequencer 118 may further include hardware (or processor implemented instructions) to set the specified bit to add the new entry to the apparatus 100. In this regard, setting the specified bit may refer to the valid bit associated with the specific system memory block or cache line.

If the corresponding bit in the 4-bit field discussed above is not set, then a comparison may be made of the state and ownership information. If the state and ownership information as read from the state information 110 are not the same as the state and ownership information associated with the new tag, then this new tag may be added to the TCAM 106. In this regard, based on a determination that the state and the ownership associated with the new entry are respectively not identical to the state and the ownership associated with the previous entry, the hardware sequencer 118 may further include hardware (or processor implemented instructions) to add the new entry to the coherency directory tag 104 as a different entry than the previous entry.

The hardware sequencer 118 may further include hardware (or processor implemented instructions) to determine whether the state or the ownership associated with the one of the adjacent cache lines has changed. Based on a determination that the state or the ownership associated with the one of the adjacent cache lines has changed, the hardware sequencer 118 may further include hardware (or processor implemented instructions) to designate the one of the adjacent cache lines for which the state or the ownership has changed as a new entry. The hardware sequencer 118 may further include hardware (or processor implemented instructions) to determine whether the TCAM 106 includes another entry corresponding to the new entry, for example, by searching the TCAM 106 for a matching entry. Based on a determination that the TCAM 106 does not include the another entry corresponding to the new entry, the hardware sequencer 118 may further include hardware (or processor implemented instructions) to add the new entry into an unused entry location of the TCAM 106.

The current TCAM entry, the one that just matched, may also need to be updated to clear the “don't care” programming of one or more of the lower tag bits. This update may be needed so that this entry will not match the next time the current tag is used to search the TCAM 106.

Based on a determination that the TCAM 106 does not include the other entry corresponding to the new entry, the hardware sequencer 118 may further include hardware (or processor implemented instructions) to determine whether all entry locations in the TCAM 106 are used. Based on a determination that all entry locations in the TCAM 106 are used, the hardware sequencer 118 may further include hardware (or processor implemented instructions) to evict a least recently used entry of the TCAM 106. The hardware sequencer 118 may further include hardware (or processor implemented instructions) to add the new entry into an entry location corresponding to the evicted least recently used entry of the TCAM 106.

Based on a determination that the state or the ownership associated with the one of the adjacent cache lines has changed, the hardware sequencer 118 may further include hardware (or processor implemented instructions) to clear a programming associated with the one of the adjacent cache lines for which the state or the ownership has changed to remove the one of the adjacent cache lines for which the state or the ownership has changed from the grouped cache lines.

According to an example, assuming that the coherency directory tag 104 includes an entry for 10X, a validity field 0011, and a state/ownership SO, and a snoop request is received for cache line address 110, which has state/ownership SO, then the entry for 10X may be updated to address 1XX, the validity field may be set to 0111, and SO may be returned in response to the snoop.

Part of the information in the processor snoop request and the node controller request may be used to determine how the select on the multiplexer 102 is to be driven. If there is a processor snoop request and no node controller request, the process state machine 114 may drive the select line to the multiplexer 102 to select the processor snoop request.

The process state machine 114 may control the multiplexer 102 in the example implementation of FIG. 1. The process state machine 114 may receive part of the amplifying information related to a different request that is selected.

With respect to information sent from the match encoder 108 to the process state machine 114 and LRU tracking circuit 112, the process state machine 114 and LRU tracking circuit 112 may receive both the match/not match indicator and the TCAM row address of the matching entry from the match encoder 108.

The directory state output shown in FIG. 1 may include the state and the ownership information for a matching request. The directory state output may be sent to other circuits within the node controller or processor application-specific integrated circuit (ASIC) where the apparatus 100 is located. The other circuits may include the circuit that sent the initial request to the coherency directory cache.

The cache hit/miss state output shown in FIG. 1 may represent an indication as to whether the request matched an entry within the coherency directory cache or not. The cache hit/miss state output may be sent to other circuits within the node controller or processor ASIC where the apparatus 100 is located. The other circuits may include the circuit that sent the initial request to the coherency directory cache.

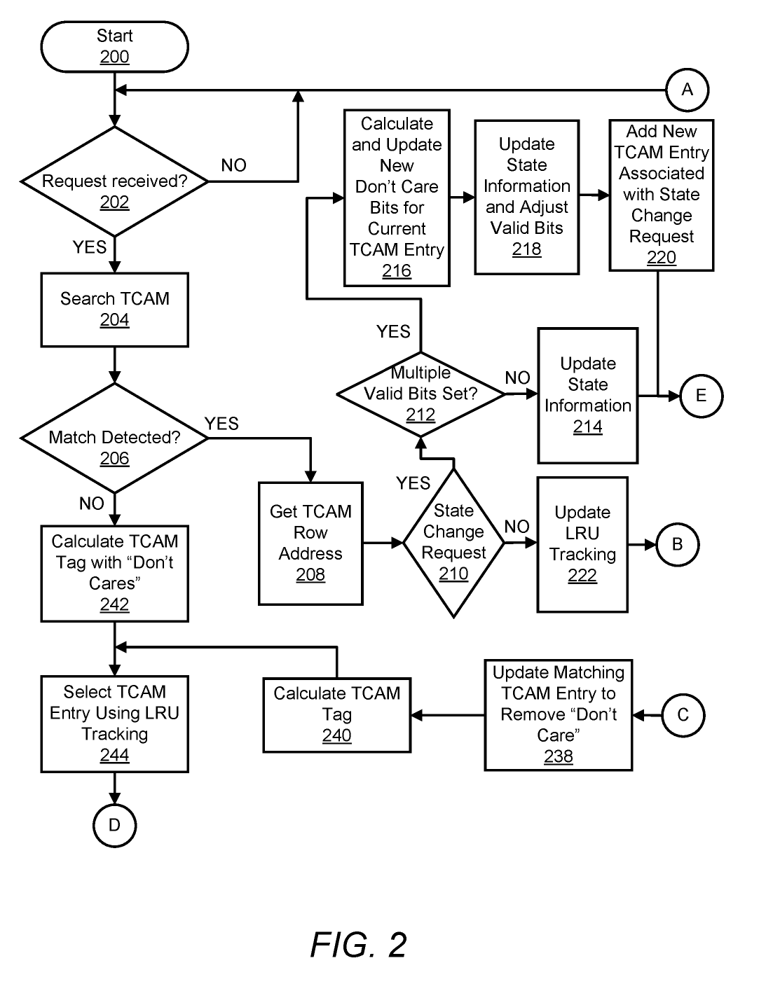

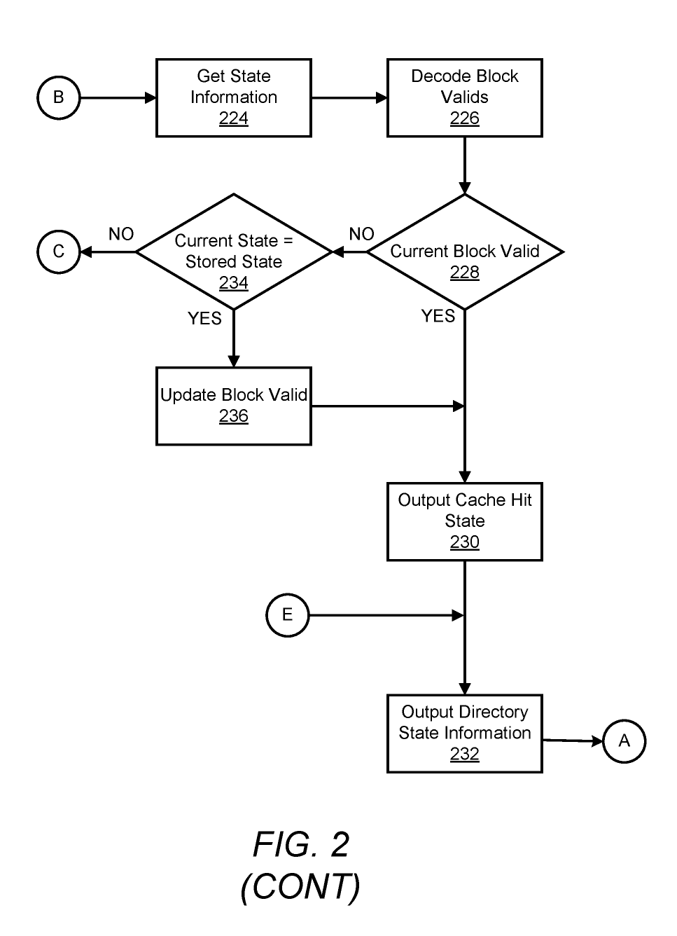

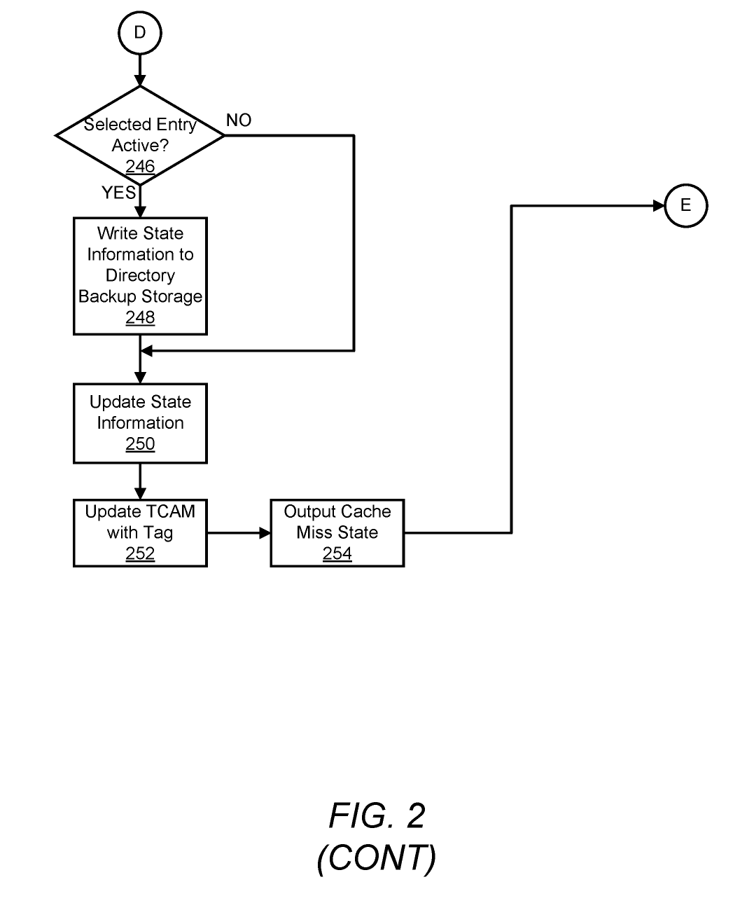

FIG. 2 illustrates a process flow to illustrate operation of the apparatus 100. The process flow may be performed by the process state machine 114. Various operations of the process state machine 114 may be performed by the hardware sequencer 118.

Referring to FIG. 2, at block 200, the process flow with respect to operation of the process state machine 114 may start.

At block 202, the process state machine 114 may determine whether a request (e.g., processor snoop request, node controller request, etc.) has been received.

Based on a determination at block 202 that the request (e.g., processor snoop request, node controller request, etc.) has been received, at block 204, the process state machine 114 may trigger the TCAM 106 to search the coherency directory tag 104. In this regard, the address associated with the cache line that is included in the received request may be used to search for a matching tag value. As disclosed herein, for the TCAM 106 implemented coherency directory tag 104, each cache entry may include a TCAM entry to hold the upper address to compare against. This upper address may be referred to as a tag. The directory tags may represent the portion of the directory address that uniquely identifies the directory tags. The tags may be used to detect the presence of a directory cache line within the apparatus 100, and, if so, the matching entry may identify where in the directory state information 110 storage the cached information is located.

At block 206, the process state machine 114 may determine whether a match is detected in the TCAM 106 with respect to the request. According to an example, assuming that a request is received for address 1110, with respect to TCAM entries for address 1111, address 111X, and address 11XX (e.g., with up to two least significant digit don't care bits), matches may be determined as follows. The 0 bit of the received address does not match the corresponding 1 bit of the TCAM address 1111, and thus a miss would result. Conversely, the 0 bit of the received address is not compared to the corresponding X bits of the TCAM addresses 111X and 11XX, resulting in a match.

Based on a determination at block 206 that a match is detected, at block 208, the process state machine 114 may obtain the TCAM row address associated with the match at block 206.

At block 210, a determination may be made as to whether the request at block 202 is a state change request. Based on a determination at block 210 that the request at block 202 is a state change request, the process state machine 114 may proceed to block 212. At block 212, the process state machine 114 may examine stored state information to determine if multiple valid bits are set.

Based on a determination at block 212 that multiple valid bits are not set, at block 214, the state information may be updated.

Based on a determination at block 212 that multiple valid bits are set, at block 216, the process state machine 114 may calculate and update new don't care bits for the current TCAM entry. For example, for a single TCAM entry representing four memory blocks, the most significant don't care bit may be cleared, and changed from don't care to a match on one (or zero).

At block 218, the process state machine 114 may update state information and adjust valid bits. For example, for the match on one as discussed above, for associated state information valid bits that are all 1111, the valid bits may be changed to 1100.

At block 220, the process state machine 114 may add a new TCAM entry associated with the state change request. In this regard, the process state machine 114 may write the entry into the TCAM and write the associated state information that matches the address associated with the state change request.

Based on a determination at block 210 that the request at block 202 is not a state change request, the process state machine 114 may proceed to block 222. At block 222, the process state machine 114 may update the least recently used tracking circuit 112 with respect to the match to move the TCAM row address to the top of a list of TCAM row addresses to indicate usage of the TCAM row address as a most recently used TCAM row address.

At block 224, the process state machine 114 may get the state information with respect to the match from the state information 110. The state information 110 may be described as a memory or storage element that may be written and read. In the example implementation of FIG. 1, the state information 110 may be stored in a static random-access memory (SRAM), or another type of memory.

At block 226, the process state machine 114 may decode memory block valid bits. The system memory block valid or cache line valid bits may be located within the state information 110 storage. In this regard, if the TCAM row address represents an entry that represents more than one cache line, then the process state machine 114 may decode the associated block valid bits to identify the valid bit associated with the system memory block. According to an example, if the TCAM row address of seven represents an entry that represents more than one cache line, then the process state machine 114 may decode the associated block valid bits of binary 1101 to identify the valid bit of 1 associated with the system memory block.

At block 228, the process state machine 114 may determine whether the current block is valid. For example, the process state machine 114 may determine whether the associated block valid bit is active or inactive (i.e., where active/inactive may be used to describe the state of a valid bit without defining if “1” or “0” state represents valid or not valid). In this regard, an implementation may define whether 1 is valid or invalid. However, other implementations may define an opposite mapping.

Based on a determination at block 228 that the current block is valid, at block 230, the process state machine 114 may output the cache hit/miss state. The cache hit/miss state may be output to the node controller/processor requester, and other parts of the ASIC that may include the requester.

At block 232, the process state machine 114 may output the directory state information responsive to the request received at block 202.

Based on a determination at block 228 that the current block is not valid, at block 234, the process state machine 114 may determine whether a current state of the current request being processed is equal to a stored state. The current state may be determined from a look-up to the coherency directory. The stored state may be described in the information stored in state information 110. The stored state may include the state and ownership information of the cache line(s) being held in the coherency directory cache. In this regard, the process state machine 114 may determine whether the state between the block associated with the received request at block 202 and the stored state are the same. The stored state information may represent information related to the current coherency cache entry. This conformation may utilize additional information (e.g., by reading the current state) from the full coherence directory.

Based on a determination at block 234 that the current state is equal to the stored state, at block 236, the process state machine 114 may update the block valid bit associated with the new memory block. In this regard, the valid bit for the new block may be set.

Based on a determination at block 234 that the current state is not the same as the stored state, at block 238, the process state machine 114 may update the matching TCAM entry to remove “don't care”. In this regard, since the TCAM entry cannot be shared, the “don't care” TCAM entry may be removed as individual TCAM entries are now needed. In this regard, the “don't care” bit may be changed or removed within the TCAM entry to now utilize a more precise match with any new incoming request. If the state or ownership of one of the four system cache lines as discussed above needs an update in the state or ownership information and other cache lines that share a TCAM entry are not updated, the new tag may be added to the TCAM 106 as described above. The current TCAM entry, the one that just matched, may also need to be updated to clear the “don't care” programming of one or more of the lower tag bits. This update may be needed so that this entry will not match the next time the current tag is used to search the TCAM 106 as the state and ownership information is no longer the same, and they may no longer share a TCAM entry. According to an example, assuming that the TCAM includes entry 00XX, and there are valid bits for 0000, 0001, and 0010 and an invalid bit for 0011, a request for 0011 is received, and 0011 has different state/ownership than the rest (e.g., 0000, 0001, and 0010), at blocks 238 and 240, the TCAM entry may be changed to 000X, and a new entry for 0011 may be added. With respect to 0010, two new entries may be added (e.g., one for 0010 and one for 0011).

At block 240, the process state machine 114 may determine a TCAM tag for the new TCAM entry, and update the state information accordingly. With respect to block 240, block 240 may not use “don't cares” because the state information associated with the new request does not match the state or ownership information stored in the coherency directory cache. That is, the TCAM entry may need to be more precise and cannot represent a group of system memory blocks or cache line.

Based on a determination at block 206 that a match is not detected, at block 242, the process state machine 114 may determine a TCAM tag with “don't cares” associated with the group of memory blocks represented by the requesting block's address. For block 242, with respect to the path from block 206 to block 242, this path does allow a TCAM entry to represent a group of system memory blocks or cache lines as this is the first request within the group of system memory blocks or cache lines, and being the first one in the cache, a comparison against any stored state or ownership information that may be stored in state information 110 is not needed.

At block 244, the process state machine 114 may select the TCAM entry using the least recently used tracking circuit 112. That is, the process state machine 114 may select the row/location for the new TCAM entry, and select a TCAM entry for eviction. For the example implementation of FIG. 1, the unused entries may also represent the least recently used.

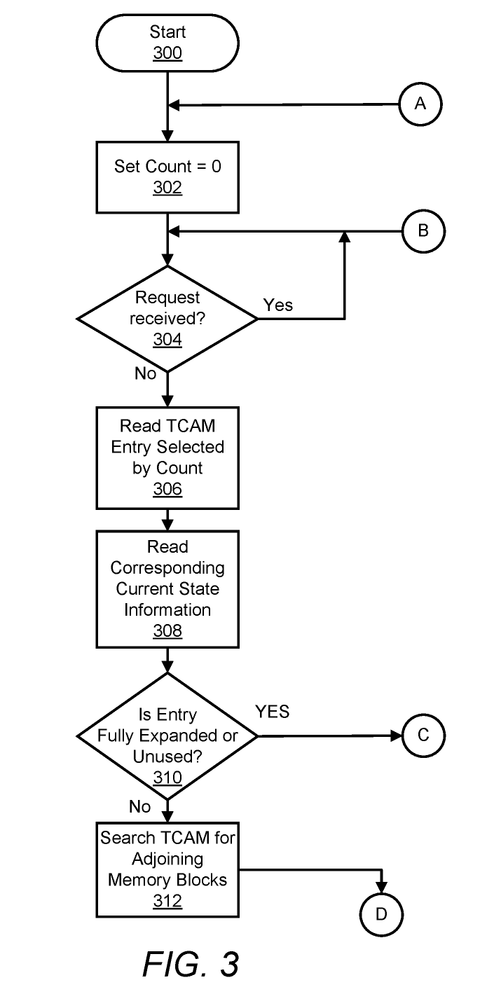

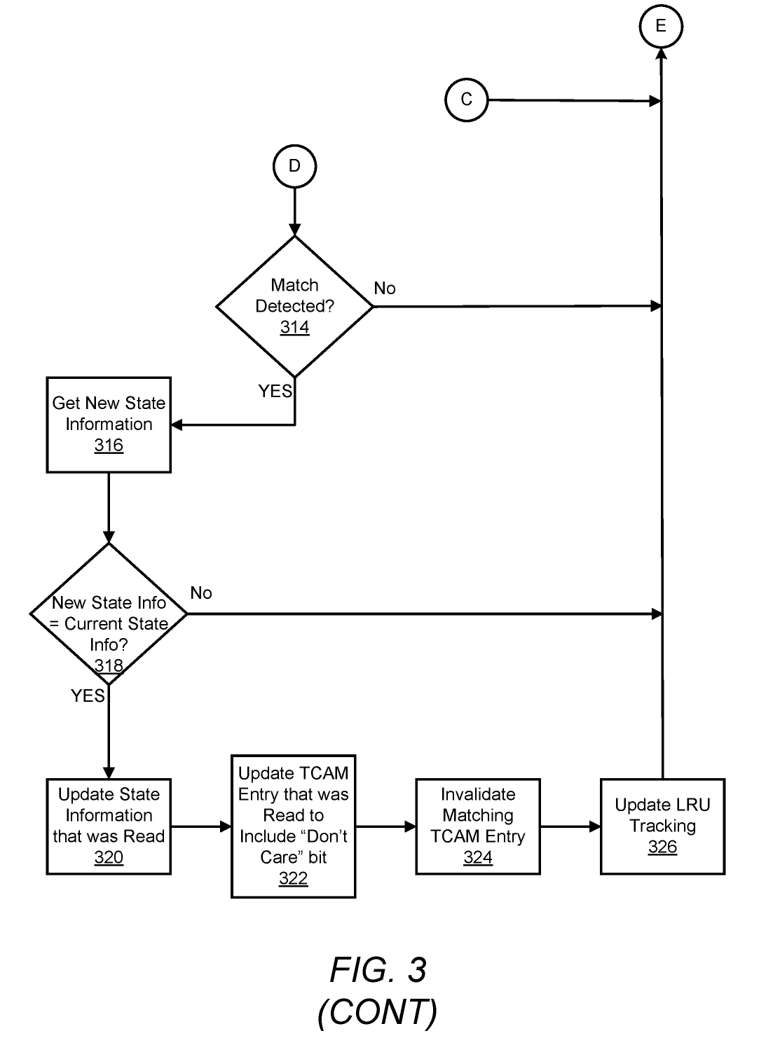

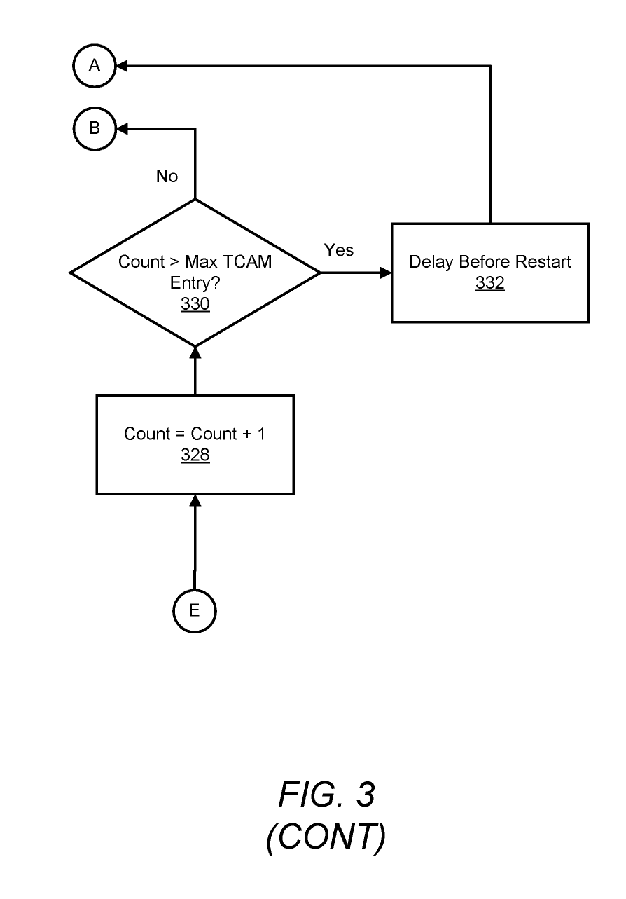

At block 246, the process state machine 114 may determine whether the selected TCAM entry from block 244 is active. The TCAM may include a “never match” state to identify an entry as being invalid. A TCAM entry may change from active to inactive if a TCAM entry may not have been used, a background scrubbing operation as disclosed herein with respect to FIG. 3 has combined multiple TCAM entries to a single entry, or the TCAM entry is evicted.

Based on a determination at block 246 that the selected TCAM entry from block 244 is active, at block 248, the process state machine 114 may write state information to the coherency directory that the cache is operating on. Further, at block 250, the process state machine 114 may update state information.

Based on a determination at block 246 that the selected TCAM entry from block 244 is not active, at block 250, the process state machine 114 may update the TCAM entry associated state information entry, for example, by writing the TCAM new entry to the location of the previous TCAM entry.

At block 252, the process state machine 114 may update the TCAM 106 with the tag as determined at block 242.

At block 254, the process state machine 114 may output a cache miss state to the original requesting circuit or other parts of the node controller or processor containing the coherency directory cache.

With respect to FIG. 2, when a cache line request that is received is going to modify the current don't care bits, a new TCAM entry may be made to cover the new pair of system memory blocks, but the valid bits may be marked for the memory block that the cache line request pertains to.

FIG. 3 illustrates a scrubber flow to illustrate operation of the apparatus 100. The scrubber flow may be performed by the background scrubbing state machine 116. Various operations of the background scrubbing state machine 116 may be performed by the hardware sequencer 120. The operations performed by the background scrubbing state machine 116 may be performed when an entry's state information is updated, but this operation may utilize additional TCAM searches and write operations, and the process state machine 114 may be busy processing the next request and be unable to perform these operations. Thus, the background scrubbing state machine 116 may be performed without interfering with operations of the process state machine 114.

Referring to FIG. 3, at block 300, the scrubber flow with respect to operation of the scrubbing state machine 116 may start.

At block 302, the scrubbing state machine 116 may set a count value to zero. The count value may be set to zero to effectively analyze all content of the TCAM 106.

At block 304, the scrubbing state machine 116 may determine whether a request (e.g., processor snoop request, node controller request, etc.) has been received.

Based on a determination at block 304 that a request (e.g., processor snoop request, node controller request, etc.) has been received, processing may revert to block 304 until the request is processed by the process state machine 114.

Based on a determination at block 304 that a request (e.g., processor snoop request, node controller request, etc.) has not been received, at block 306, the scrubbing state machine 116 may read a TCAM entry selected by the count at block 302. The count may be used as the row number for the TCAM entry being analyzed, where the row number may represent the address of the TCAM entry.

At block 308, the scrubbing state machine 116 may read a current state information for the TCAM entry read at block 306.

At block 310, the scrubbing state machine 116 may determine whether an associated entry (e.g., from block 306) is fully expanded in that all possible memory blocks are represented by a single entry, or is unused. When the TCAM entry is read, the lower bits of the tag may be examined. If the state of the lower tag bits match the values associated with all of the possible “don't cares”, then the associated entry is fully expanded. The state information 110 may also be read to examine the valid bits.

Based on a determination at block 310 that the associated entry is used and not fully expanded, at block 312, the scrubbing state machine 116 may search the TCAM for adjoining memory blocks. In the example disclosed, the TCAM 106 may include a bit field associated with the search operation that allows for a global “don't cares” in the search. The lower bits of the search may be set to “don't care” and a TCAM search may be performed. In this regard, the hardware sequencer 120 may further include hardware (or processor implemented instructions) to identify, for the coherency directory tag 104 that includes information related to a plurality of cache lines, adjacent cache lines. In this regard, the TCAM may include a global “don't cares” bit mask that allows for exclusion of bits in a search operation. In this example, the global “don't cares” bit mask may be applied to the lower address bits of the coherency directory tag 104.

At block 314, the scrubbing state machine 116 may determine whether a TCAM match is detected. The scrubbing state machine 166 may further determine a state and an ownership associated with each of the detected adjacent cache lines.

Based on a determination at block 314 that a match is detected, at block 316, the scrubbing state machine 116 may get new state information associated with newly matched entry. In this regard, the entry based on the count value may be excluded from the search or consideration to prevent a match on the wrong entry. Further, TCAM entries that have a row address greater than the count value may be searched and considered.

At block 318, the scrubbing state machine 116 may determine whether the new state information is the same as the current state information that was associated with the read TCAM entry based on the count value.

Based on a determination at block 318 that the new state information is the same as the current state information, at block 320, the scrubbing state machine 116 may update the state information that was read.

At block 322, the scrubbing state machine 116 may update the TCAM entry that was read based on the count value to include a “don't care” bit. The TCAM entry may be rewritten with some of the lower tag bits set to a “don't care” value. This is to allow this TCAM entry to represent multiple system memory blocks or cache lines.

At block 324, the scrubbing state machine 116 may invalidate the matching TCAM entry that was obtained by searching the TCAM.

At block 326, the scrubbing state machine 116 may update the least recently used tracking circuit 112.

At block 328, the scrubbing state machine 116 may increment the count by one.

At block 330, the scrubbing state machine 116 may determine whether the count is greater than a count associated with a maximum TCAM entry.

Based on a determination at block 330 that the count is not greater than a maximum TCAM entry, further processing may revert to block 304.

Based on a determination at block 330 that the count is greater than a maximum TCAM entry, at block 332, the scrubbing state machine 116 may implement a time delay before restart. The time delay may be omitted. However, there may be a reduced need to rescrub the coherency directory cache apparatus 100 entries again until entries have been updated. The time delay may allow for a time window when updates may have occurred. In this regard, a scrub type operation may be performed after each entry update. However, for performance reasons, the scrub type operation may be performed in the background to allow requests to be processed at a higher priority than scrubbing operations.

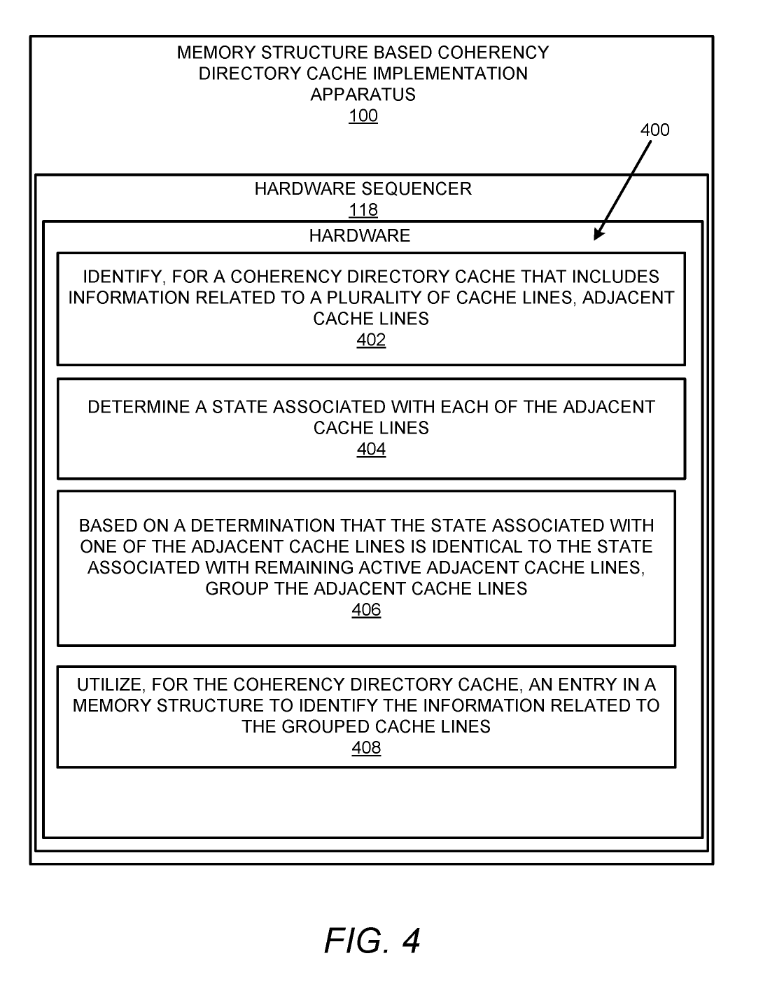

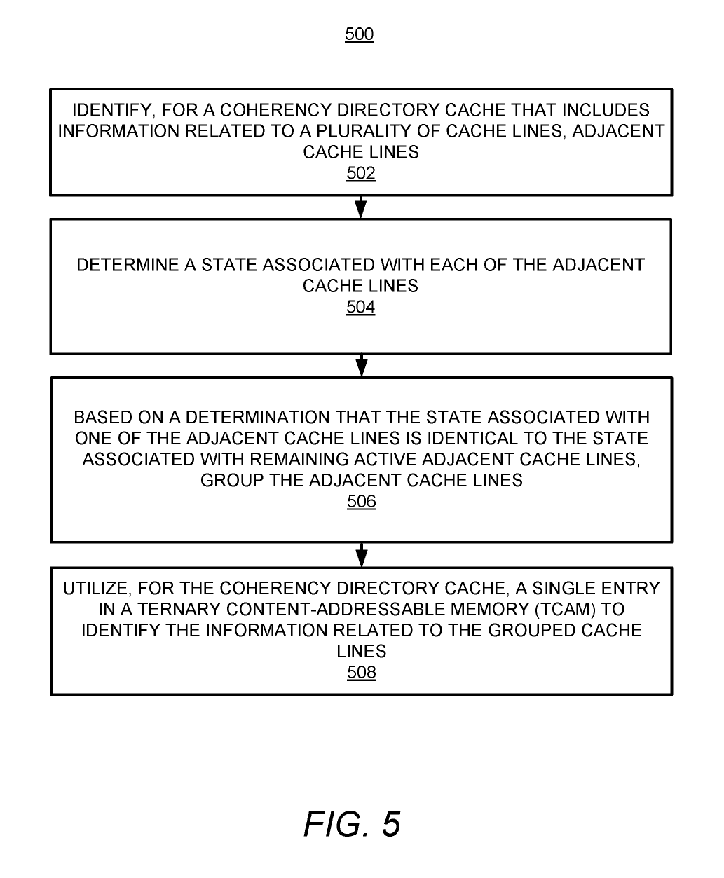

FIGS. 4-6 respectively illustrate an example block diagram 400, an example flowchart of a method 500, and a further example block diagram 600 for memory structure based coherency directory cache implementation. The block diagram 400, the method 500, and the block diagram 600 may be implemented on the apparatus 100 described above with reference to FIG. 1 by way of example and not limitation. The block diagram 400, the method 500, and the block diagram 600 may be practiced in other apparatus. In addition to showing the block diagram 400, FIG. 4 shows hardware of the apparatus 100 that may execute the steps of the block diagram 400. The hardware may include the hardware sequencer 118 (and the hardware sequencer 120) including hardware to perform the steps of the block diagram 400. Alternatively, the hardware may include a processor (not shown), and a memory (not shown), such as a non-transitory computer readable medium storing machine readable instructions that when executed by the processor cause the processor to perform the steps of the block diagram 400. The memory may represent a non-transitory computer readable medium. FIG. 5 may represent a method for memory structure based coherency directory cache implementation, and the steps of the method. FIG. 6 may represent a non-transitory computer readable medium 602 having stored thereon machine readable instructions to provide memory structure based coherency directory cache implementation. The machine readable instructions, when executed, cause a processor 604 to perform the steps of the block diagram 600 also shown in FIG. 6.

The processor (not shown) of FIG. 4 and/or the processor 604 of FIG. 6 may include a single or multiple processors or other hardware processing circuit, to execute the methods, functions and other processes described herein. These methods, functions and other processes may be embodied as machine readable instructions stored on a computer readable medium, which may be non-transitory (e.g., the non-transitory computer readable medium 602 of FIG. 6), such as hardware storage devices (e.g., RAM (random access memory), ROM (read only memory), EPROM (erasable, programmable ROM), EEPROM (electrically erasable, programmable ROM), hard drives, and flash memory). The memory (not shown) of FIG. 4 may include a RAM, where the machine readable instructions and data for a processor may reside during runtime.

Referring to FIGS. 1-4, and particularly to the block diagram 400 shown in FIG. 4, the hardware sequencer 118 (and the hardware sequencer 120) may include hardware to identify (e.g., at 402), for a coherency directory tag 104 that includes information related to a plurality of cache lines, adjacent cache lines.

The hardware sequencer 118 (and the hardware sequencer 120) may hardware to determine (e.g., at 404) a state associated with each of the adjacent cache lines.

Based on a determination that the state associated with one of the adjacent cache lines is identical to the state associated with remaining active adjacent cache lines, the hardware sequencer 118 (and the hardware sequencer 120) may include hardware to group (e.g., at 406) the adjacent cache lines.

The hardware sequencer 118 (and the hardware sequencer 120) may include hardware to utilize (e.g., at 408), for the coherency directory cache, an entry in a memory structure to identify the information related to the grouped cache lines. In this regard, data associated with the entry in the memory structure may include greater than two possible memory states.

Referring to FIGS. 1-3 and 5, and particularly FIG. 5, for the method 500, at block 502, the method may include identifying, for a coherency directory tag 104 that includes information related to a plurality of cache lines, adjacent cache lines.

At block 504 the method may include determining a state associated with each of the adjacent cache lines.

Based on a determination that the state associated with one of the adjacent cache lines is identical to the state associated with remaining active adjacent cache lines, at block 506 the method may include grouping the adjacent cache lines.

At block 508 the method may include utilizing, for the coherency directory tag 104, a single entry in a TCAM 106 to identify the information related to the grouped cache lines.

Referring to FIGS. 1-3 and 6, and particularly FIG. 6, for the block diagram 600, the non-transitory computer readable medium 602 may include instructions 606 to identify, upon receiving a request (e.g., as disclosed herein with respect to FIGS. 1 and 2) or upon completion of a previously received request (e.g., as disclosed herein with respect to FIGS. 1 and 3) related to a coherency directory tag 104 that includes information related to a plurality of cache lines, a group of a specified number of adjacent cache lines.

The processor 604 may fetch, decode, and execute the instructions 608 to determine a state and an ownership associated with each of the adjacent cache lines.

Based on a determination that the state and the ownership associated with one of the adjacent cache lines are respectively identical to the state and the ownership associated with remaining active adjacent cache lines, the processor 604 may fetch, decode, and execute the instructions 610 to utilize, for the coherency directory tag 104, an entry in a memory structure to identify the information related to the group of the specified number of adjacent cache lines. Data associated with the entry in the memory structure may include greater than two possible memory states.

What has been described and illustrated herein is an example along with some of its variations. The terms, descriptions and figures used herein are set forth by way of illustration only and are not meant as limitations. Many variations are possible within the spirit and scope of the subject matter, which is intended to be defined by the following claims—and their equivalents—in which all terms are meant in their broadest reasonable sense unless otherwise indicated.

What is claimed is:

1. An apparatus comprising:
a hardware sequencer including hardware to:
identify, for a coherency directory cache that includes information related to a plurality of cache lines, adjacent cache lines;
determine a state associated with each of the adjacent cache lines;
based on a determination that the state associated with one of the adjacent cache lines is identical to the state associated with remaining active adjacent cache lines, group the adjacent cache lines; and
utilize, for the coherency directory cache, an entry in a memory structure to identify the information related to the grouped cache lines, wherein data associated with the entry in the memory structure includes greater than two possible memory states.

2. The apparatus according to claim 1, wherein the memory structure includes a ternary content-addressable memory (TCAM).

3. The apparatus according to claim 1, wherein the entry comprises an address that uniquely identifies the entry in the memory structure.

4. The apparatus according to claim 3, wherein the hardware is further to cause the hardware sequencer to:
write a specified number of lower bits of the address as “X” bits, wherein the data associated with the entry in the memory structure includes the possible memory states of “0”, “1”, or “X”, and wherein the “X” memory state represents “0” or “1”; and
designate, based on the written lower bits, coherency directory cache tracking as valid for each cache line of the grouped cache lines.

5. The apparatus according to claim 1, wherein the entry comprises a single entry in the memory structure to identify the information related to the grouped cache lines.

6. The apparatus according to claim 1, wherein a number of the grouped cache lines is equal to four adjacent cache lines.

7. The apparatus according to claim 1, wherein the hardware is further to cause the hardware sequencer to:
utilize the entry to designate
zero cache lines,
not a valid entry associated with the cache lines, or
a specified number of the adjacent cache lines, where the specified number is greater than one.

8. The apparatus according to claim 1, wherein the hardware is further to cause the hardware sequencer to:
designate the entry as a new entry;
determine whether the memory structure includes a previous entry corresponding to the new entry; and
based on a determination that the memory structure does not include the previous entry corresponding to the new entry, add the new entry into an unused entry location of the memory structure.

9. The apparatus according to claim 1, wherein the hardware is further to cause the hardware sequencer to:
designate the entry as a new entry;
determine whether the memory structure includes a previous entry corresponding to the new entry;
based on a determination that the memory structure does not include the previous entry corresponding to the new entry, determine whether all entry locations in the memory structure are used;
based on a determination that all entry locations in the memory structure are used, evict a least recently used entry of the memory structure; and
add the new entry into an entry location corresponding to the evicted least recently used entry of the memory structure.

10. The apparatus according to claim 1, wherein the hardware is further to cause the hardware sequencer to:
designate the entry as a new entry;
determine whether the memory structure includes a previous entry corresponding to the new entry;
based on a determination that the memory structure includes the previous entry corresponding to the new entry, determine, for the previous entry, whether a specified bit corresponding to the new entry is set;
based on a determination that the specified bit is set, designate the new entry as a cache hit.

11. The apparatus according to claim 10, wherein the hardware is further to cause the hardware sequencer to:
based on a determination that the specified bit is not set, determine whether a state associated with the new entry is identical to the state associated with the previous entry;
based on a determination that the state associated with the new entry is identical to the state associated with the previous entry, set the specified bit to add the new entry to the coherency directory cache.

12. The apparatus according to claim 11, wherein the hardware is further to cause the hardware sequencer to:
based on a determination that the state associated with the new entry is not identical to the state associated with the previous entry, add the new entry to the coherency directory cache as a different entry than the previous entry.

13. A computer implemented method comprising:
identifying, for a coherency directory cache that includes information related to a plurality of cache lines, adjacent cache lines;
determining a state associated with each of the adjacent cache lines;
based on a determination that the state associated with one of the adjacent cache lines is identical to the state associated with remaining active adjacent cache lines, grouping the adjacent cache lines; and
utilizing, for the coherency directory cache, a single entry in a ternary content-addressable memory (TCAM) to identify the information related to the grouped cache lines.

14. The method according to claim 13, further comprising:
determining whether the state associated with the one of the adjacent cache lines has changed;
based on a determination that the state associated with the one of the adjacent cache lines has changed, designating the one of the adjacent cache lines for which the state has changed as a new entry;
determining whether the TCAM includes another entry corresponding to the new entry; and
based on a determination that the TCAM does not include the another entry corresponding to the new entry, adding the new entry into an unused entry location of the TCAM.

15. The method according to claim 13, further comprising:
determining whether the state associated with the one of the adjacent cache lines has changed;
based on a determination that the state associated with the one of the adjacent cache lines has changed, designating the one of the adjacent cache lines for which the state has changed as a new entry;
determining whether the TCAM includes another entry corresponding to the new entry;
based on a determination that the TCAM does not include the another entry corresponding to the new entry, determining whether all entry locations in the TCAM are used;
based on a determination that all entry locations in the TCAM are used, evicting a least recently used entry of the TCAM; and
adding the new entry into an entry location corresponding to the evicted least recently used entry of the TCAM.

16. The method according to claim 13, further comprising:
determining whether the state associated with the one of the adjacent cache lines has changed; and
based on a determination that the state associated with the one of the adjacent cache lines has changed, clearing a programming associated with the one of the adjacent cache lines for which the state has changed to remove the one of the adjacent cache lines for which the state has changed from the grouped cache lines.

17. A non-transitory computer readable medium having stored thereon machine readable instructions, the machine readable instructions, when executed, cause a processor to:
identify, upon receiving a request or upon completion of a previously received request related to a coherency directory cache that includes information related to a plurality of cache lines, a group of a specified number of adjacent cache lines;
determine a state and an ownership associated with each of the adjacent cache lines; and
based on a determination that the state and the ownership associated with one of the adjacent cache lines are respectively identical to the state and the ownership associated with remaining active adjacent cache lines, utilize, for the coherency directory cache, an entry in a memory structure to identify the information related to the group of the specified number of adjacent cache lines, wherein data associated with the entry in the memory structure includes greater than two possible memory states.

18. The non-transitory computer readable medium according to claim 17, wherein the specified number of adjacent cache lines is equal to four adjacent cache lines.

19. The non-transitory computer readable medium according to claim 17, wherein the memory structure includes a ternary content-addressable memory (TCAM).

20. The non-transitory computer readable medium according to claim 17, wherein the entry comprises an address that uniquely identifies the entry in the memory structure, and wherein the machine readable instructions, when executed, further cause the processor to:
write a specified number of lower bits of the address as “X” bits, wherein the data associated with the entry in the memory structure includes the possible memory states of “0”, “1”, or “X”, and wherein the “X” memory state represents “0” or “1”; and
designate, based on the written lower bits, coherency directory cache tracking as valid for each cache line of the group of the specified number of adjacent cache lines.
